(19) United States
(12) Patent Application Publication
(10) Pub. No.: US 2010/0014646 A1
(43) Pub. Date: Jan. 21, 2010

(54) TTY Translation for VoIP

(75) Inventors: Elizabeth A. Bauer, Appleton, WI (US); Nicholas F. Campion, Rochester, MN (US); Keith D. Cramer, Pine Island, MN (US); Lisa McGarthwaite, Minnetonka, MN (US); Shauna B. Smith, Rochester, MN (US); Lucas A. Will, Rochester, MN (US)

Correspondence Address: CANTOR COLBURN LLP - IBM ROCHESTER DIVISION, 20 Church Street, 22nd Floor, Hartford, CT, 06103, US

(73) Assignee: International Business Machines Corporation, Armonk, NY (US)

(21) Appl. No.: 12/174,839

(22) Filed: Jul. 17, 2008

(51) Int. Cl. H04L 12/66; H04M 11/00

(52) U.S. Cl. 379/52; 370/352

(57) ABSTRACT

A device for transmitting TTY communications includes an input for receiving analog tones from a TTY device, a first output for connecting to a public telephone switch network (PSTN) and a second output for connecting to digital communications network. The device is configured to operate in a first mode and a second mode. In the first mode the device receives the analog tones at the input and transmits the analog tones over the PSTN through the first output. In the second mode, the device receives the analog tones at the input, converts the analog tones into transmission control protocol (TCP) packets and transmits the TCP packets over a digital communications network through the second output.

### BACKGROUND

The present invention relates generally to Voice over Internet Protocol (VoIP) and, more particularly, to translating TTY (Teletype) communications for VoIP communications.

Voice-over-Internet-Protocol (VoIP) is a rapidly emerging technology. VoIP telephony may have advantages over standard telephony. For example, VoIP telephony may allow organizations to use the same network for both computers and telephones. However, as VoIP is a relatively new technology, it still has many areas in which it has much room for improvement, one of which is quality of service (QoS).

Computer networks are imperfect. When transmitted, data packets get altered and lost and are sometimes delivered out of order. However, on a normal network, the order in which packets arrive is irrelevant. As a result, in the transmission control protocol (TCP) network protocol, which is the standard protocol for sending data over a network, packets that are corrupted are simply re-sent. In this way, TCP guarantees delivery for all data transmitted.

However, in the context of VoIP, packets must arrive in approximately the correct order for the conversation to be successfully reconstructed. Even if a few packets are lost, the human ear can reconstruct what was said. However, the human ear cannot reconstruct a conversation if the packets arrive out of order. Therefore, VoIP uses a different networking protocol—the user datagram protocol (UDP)—which does not guarantee delivery for all packets but does guarantee the order of packets. As a result, when network congestion is particularly bad, VoIP conversations can get garbled beyond all recognition.

Even if the sound is a little garbled, a human ear can successfully reconstruct what was said. However, the same is not true for machines. Teletype (TTY) devices like those used by people who are hearing impaired, have a particularly hard time reconstructing a garbled signal. TTY devices function by sending a series of tones that represent each character that a user types on the device's keyboard. Those tones are then interpreted by the TTY device on the other end of the connection and displayed on the screen of the other user's TTY device.

This procedure works well on the standard telephone network, however, over a VoIP network it is somewhat less than ideal. First, the conversation must be translated twice—once from characters (digital data) into tones (analog data), and then back to characters (digital data) before being transmitted. The same process is then repeated on the receiving side. Furthermore, because VoIP uses UDP, it is possible that packets that make up the TTY's tones could get lost. If a sufficient number of packets are lost, it will be impossible for the listening TTY device to decipher the signal that was sent.

What is needed to solve this problem is a new way to send TTY conservations on a VoIP network with high reliability.

### SUMMARY

One embodiment of the present invention is directed to a device for transmitting TTY communications. The device of this embodiment includes an input for receiving analog tones from a TTY device. The device of this embodiment also includes a first output for connecting to a public telephone switch network (PSTN) and a second output for connecting to digital communications network. The device of this embodiment is configured to operate in a first mode and a second mode. In the first mode the device receives the analog tones at the input and transmits the analog tones over the PSTN through the first output. In the second mode, the device receives the analog tones at the input, converts the analog tones into transmission control protocol (TCP) packets and transmitts the TCP packets over a digital communications network through the second output.

Another embodiment of the present invention is directed to a method for transmitting a TTY communication over a VoIP network. The method of this embodiment includes receiving a first series of analog tones from a TTY device; converting the series of tones into a first digital representation; forming TCP packets based on the digital representation; transmitting the TCP packets to a destination over a communications network; receiving the TCP packets at the destination; and converting the TCP packets to a second series of analog tones.

Another embodiment of the present invention is directed to a method of conducting a TTY based communication utilizing voice over Internet protocol (VoIP). The method of this embodiment includes determining a hardware configuration of a recipient of a call; setting a first functional exchange station (FXS) to a digital mode based on the hardware configuration; receiving a first plurality of analog tones at the FXS; converting the analog tones into TCP packets; transmitting the TCP packets over a digital communications network; receiving the TCP at a second FXS; converting the TCP packets to second plurality of analog tones; and converting the second plurality of analog tones into a digital form.

### BRIEF DESCRIPTION OF THE DRAWINGS

Referring to the exemplary drawings wherein like elements are numbered alike in the several Figures:

FIG. 1 shows an embodiment of a system according to one embodiment of the present invention; and

FIG. 2 shows a flow chart of a method according to one embodiment of the present invention.

### DETAILED DESCRIPTION

Embodiments of the present invention are directed systems and methods for transmitting TTY communications over a VoIP network. In one embodiment, a special functional exchange station (FXS) is connected to a standard TTY device to allow hearing impaired people to use their existing TTY devices on a VoIP network. In particular, a caller would use their TTY devices to dial a telephone number, exactly like they normally would, and then the caller's special FXS device detects whether the destination number included a TTY device connected to a similar FXS device. In such an instance, the FXS device translates the analog tones sent out by the TTY device into digital data and puts the digital data into TCP packets to be sent over the Internet. These TCP packets would then be translated back into analog tones by receiver side FXS device.

Operating in such a manner is fundamentally different than how TTY devices currently work on either the traditional public switched telephone network (PSTN) or a VoIP network. In the case of PSTN network, the TTY characters are converted to analog tones. In the case of current VoIP networks the TTY characters are converted to analog tones that are then packaged as digital signal frames and sent as UDP data. Once received, the UDP digital signal frames are reconverted back to analog signals for the TTY device. The present invention may allow TTY characters to be sent as according to the transmission control protocol (TCP) as digital signal frames between the two TTY devices because the underlying network may utilize VoIP which can handle the digital data transmission.

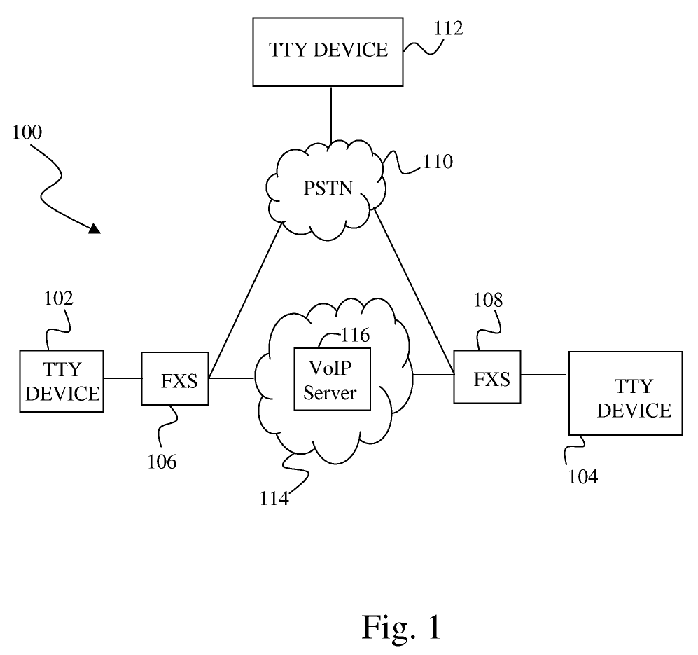

FIG. 1 shows an example of system 100 according to an embodiment of the present invention. The system may include a first TTY device 102. The first TTY device 102 may be any type of device that receives an input (typically from a keyboard) and converts the input into an analog signal. For instance, each letter may have a particular tone associated with it. The system 100 may also include at least one additional TTY device such as the second TTY device 104. Of course, the system 100 may include additional TTY devices and is, therefore, not limited to two TTY devices as shown in FIG. 1.

The first and second TTY devices 102 and 104 are, respectively, connected to the first FXS device 106 and the second FXS device 108. In one embodiment, the FXS devices 106 and 108 may operate in at least two different modes. In an analog mode, the FXS device may operate in a conventional manner. That is, the FXS may receive the analog input from the TTY device to which it is connected and may pass the analog input to a conventional public switch telephone network (PSTN) 110. In another embodiment, the FXS may operate in a digital mode. In the digital mode, the FXS device translates the analog signal into transmission control protocol (TCP) packets over a digital communications network 114. In some embodiments, the digital communications network 114 may be coupled to a VoIP server 116. The VoIP server 116 may operate in the conventional manner. The system 100 may also include a third TTY device 112 coupled to the PSTN 110.

The digital communications network 114 may be any type of known network including, but not limited to, a wide area network (WAN), a public switched telephone network (PSTN) a local area network (LAN), a global network (e.g. Internet), a virtual private network (VPN), and an intranet. The digital communications network 114 may be implemented using a wireless network or any kind of physical network implementation known in the art.

The FXS devices, for example the first FXS device 102, may be configured to determine the type of receiving device at the other end of a call when the call is initiated. For instance, the receiving device may be a standard TTY device such as the third TTY device 112 or it may be device that includes an FXS according to the present invention coupled to a standard TTY device (e.g., the second FXS 108 and the second TTY device 104). If it is determined that the similarly configured FXS is a part of the receiving device, the FXS operated is the digital mode and transmits the communication through the VoIP server 116. Otherwise, the FXS operates in the analog mode and transmits it message over the PSTN 110.

When operating in the digital mode, the FXS devices connected to the source TTY translates the analog tones generated by a conventional TTY devices into TCP packets. For example, in a call originating at the first TTY device 102, the first FXS device converts the analog signal into TCP packets. The TCP packets are then transmitted over the digital communications network 114, through the VoIP server 116, to the second FXS 108. The second FXS device 108 translates the digital packets back into an analog series of tones which are translated by the second TTY device and, ultimately, displayed to a user of the second TTY device 104.

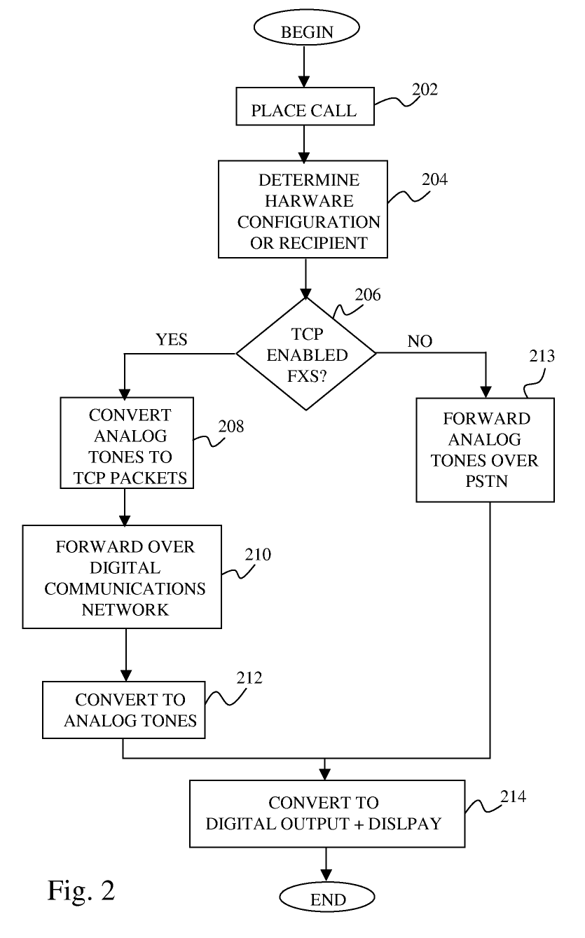

FIG. 2 depicts a method of sending a TTY message according to an embodiment of the present invention. At a block 202 a user of a TTY system having an FXS device as described above places a call to another user who also utilizes a TTY device. The call may be placed in the normal manner. For example, the user may dial a conventional phone and place it in a cradle of the TTY device.

At a block 204, an FXS device attached to the TTY device may then determine the hardware configuration of recipient of the call. The determination may be done in any manner. One example of how the determination may be made is to consult a table that may be stored, for example, in a VoIP server and that may contain records of all FXS devices having the functionality described herein. Another example may include sending interrogation packets to the receiver and requesting a response if the receiver has a hardware configuration capable of receiving TCP packets.

At a decision block 206 it is determined if the receiver includes a TCP enabled FXS device. If the receiver includes a TCP enabled FXS device, the user's FXS device operates in the above describe digital mode and, at a block 208 converts analog tones received from the TTY device into TCP packets. At a block 210 the TCP packets are forwarded to the receiver over a digital communications network. At a block 212, the TCP packets received by the receiver are converted into analog tones by the FXS device at the receiver. At a block 214, the analog tones are converted to a digital format by the receiver's TTY device and displayed to the receiver.

If it is determined at a block 206 that the receiver has a hardware configuration that does not include a TCP enabled FXS, the user's FXS forwards the analog tones received to the recipient over a PSTN as shown at block 213. In the conventional manner, the analog tones are then converted into digital format by the receiver's TTY device and displayed to the receiver at a block 214.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A device for transmitting TTY communications, the device comprising:
an input for receiving analog tones from a TTY device;
a first output for connecting to a public telephone switch network (PSTN); and
a second output for connecting to digital communications network;
wherein the device is configured to operate in a first mode and a second mode, in the first mode the device receiving the analog tones at the input and transmitting the analog tones over the PSTN through the first output, in the second mode, the device receiving the analog tones at the input, converting the analog tones into transmission control protocol (TCP) packets and transmitting the TCP packets over a digital communications network through the second output.

2. The device of claim 1, wherein the device is configured to determine a hardware configuration of a recipient of a call placed from the TTY device.

3. The device of claim 2, wherein the device operates in the first mode when the hardware configuration is of a first type.

4. The device of claim 2, wherein the device operates in the second mode when the hardware configuration of a second type.

5. The device of claim 4, wherein the hardware configuration of the second type includes device configured to receive TCP packets.

6. The device of claim 1, wherein the device is coupled to a digital communications network and a PSTN.

7. The device of claim 6, wherein the communications network is coupled to a VoIP server.

8. The device of claim 1, wherein the device is coupled to a TTY device.

9. The device of claim 1, wherein the first output and the second output are a same output.

10. A method of transmitting a TTY communication over a VoIP network, the method comprising:
receiving a first series of analog tones from a TTY device;
converting the series of tones into a first digital representation;
forming TCP packets based on the digital representation;
transmitting the TCP packets to a destination over a communications network;
receiving the TCP packets at the destination; and
converting the TCP packets to a second series of analog tones.

11. The method of claim 10, further comprising:
converting the second series of analog tones into a second digital representation.

12. The method of claim 11, further comprising:
displaying the second digital representation on a TTY device.

13. The method of claim 10, further comprising:
determining a hardware configuration at the destination.

14. The method of claim 13, further comprising:
operating an FXS device in a digital mode in the event the hardware configuration at the destination may receive TCP packets.

15. The method of claim 10, wherein transmitting includes transmitting the TCP packets to a VoIP server coupled to the communications network.

16. The method of claim 15, wherein the communications networks is the Internet.

17. A method of conducting a TTY based communication utilizing voice over Internet protocol (VoIP), the method comprising:
determining a hardware configuration of a recipient of a call;
setting a first functional exchange station (FXS) to a digital mode based on the hardware configuration;
receiving a first plurality of analog tones at the FXS;
converting the analog tones into TCP packets;
transmitting the TCP packets over a digital communications network;
receiving the TCP at a second FXS;
converting the TCP packets to second plurality of analog tones; and
converting the second plurality of analog tones into a digital form.

18. The method of claim 17, further comprising:
displaying a representation of the digital form of the analog tones on a screen.
